(19) United States
(12) Patent Application Publication
(10) Pub. No.: US 2025/0175104 A1
(43) Pub. Date: May 29, 2025

(54) LOCKED-ROTOR DETECTION DEVICE, SYSTEM AND METHOD

(71) Applicant: STMICROELECTRONICS (BEIJING) R&D CO., LTD., Beijing (CN)

(72) Inventors: Xiaohui LI, Beijing (CN); Pengfei SUN, Qingdao (CN)

(73) Assignee: STMICROELECTRONICS (BEIJING) R&D CO., LTD., Beijing (CN)

(21) Appl. No.: 18/840,875

(22) PCT Filed: Feb. 28, 2022
(86) PCT No.: PCT/CN2022/078454

§ 371 Date: Aug. 22, 2024

(51) Int. Cl. H02P 21/18; H02P 21/13

(52) U.S. Cl. CPC H02P 21/18; H02P 21/13; H02P 2207/05

(57) ABSTRACT

A motor controller generates first and second signals indicative of a motor back electromotive force (back emf) based on motor drive signals. The controller compares the first and second signals and detects a motor locked-rotor condition based on the comparison. The control circuitry may include a state observer, which, in operation, maintains a set of state variables based on the received signals, wherein the first signal indicative of the motor back emf is generated based on variables of the set of state variables. The controller may include a phase-locked-loop coupled to the state observer, wherein the phase-locked-loop, in operation, estimates a motor speed based on the variables of the set of state variables, wherein the second signal indicative of the motor back emf is generated based on the estimated motor speed. The motor may be a PMSM motor.

### BACKGROUND

### Technical Field

The present disclosure generally relates to motor control systems and detection of a locked rotor of a motor.

### Description of the Related Art

Motors, such as DC motors, AC motors, brushless DC (BLDC) motors, permanent magnet synchronous motors (PMSMs), etc., are used in a number of applications, such as in appliances (e.g., as pumps, drive motors, compressors in appliances such as dishwashers, washers, dryers, fans, air conditioners, etc.), vehicles (e.g., as drive and actuator motors, etc.).

The rotors on motors may become locked, which may result in inappropriate control signaling, reduced performance, inefficiencies, damage to the controller, the inverter, the motor, or both, if undetected, etc. Conventionally, sensors, such as Hall sensors or other rotor position sensors (e.g., encoders, resolvers), may be employed to detect a locked rotor condition.

### BRIEF SUMMARY

In an embodiment, a device comprises an input, which, in operation, receives signals indicative of currents and voltages of a motor drive signal, and control circuitry coupled to the input. The control circuitry, in operation: generates a first signal indicative of a motor back electromotive force (back emf) based on the received signals; generates a second signal indicative of the motor back emf based on the received signals; compares the first signal indicative of the motor back emf to the second signal indicative of the motor back emf; and detects a motor locked-rotor condition based on the comparison. In an embodiment, the control circuitry comprises: a state observer, which, in operation, maintains a set of state variables based on the received signals, wherein the first signal indicative of the motor back emf is generated based on variables of the set of state variables; and a phase-locked-loop coupled to the state observer, wherein the phase-locked-loop, in operation, estimates a motor speed based on the variables of the set of state variables, wherein the second signal indicative of the motor back emf is generated based on the estimated motor speed.

In an embodiment, a system, comprising a motor, which, in operation, receives motor drive signals; and control circuitry coupled to the motor. The control circuitry, in operation: monitors the motor drive signals; generates a first signal indicative of a motor back electromotive force (back emf) based on the monitoring; generates a second signal indicative of the motor back emf based on the monitoring; compares the first signal indicative of the motor back emf to the second signal indicative of the motor back emf; and detects a motor locked-rotor condition based on the comparing. In an embodiment, the control circuitry comprises: state observer circuitry, which, in operation, maintains a set of state variables based on the monitoring, wherein the first signal indicative of the motor back emf is generated based on variables of the set of state variables; and a phase-locked-loop coupled to the state observer circuitry, wherein the phase-locked-loop, in operation, estimates a motor speed based on the variables of the set of state variables, wherein the second signal indicative of the motor back emf is generated based on the estimated motor speed.

In an embodiment, a method of controlling a permanent magnet synchronous motor (PMSM) comprises: monitoring motor drive signals provided to the motor; generating a first signal indicative of a motor back electromotive force (back emf) based on the monitoring; generating a second signal indicative of the motor back emf based on the monitoring; comparing the first signal indicative of the motor back emf to the second signal indicative of the motor back emf; and detecting a locked-rotor condition of the motor based on the comparing. In an embodiment, the method comprises: maintaining a set of state variables based on the monitoring, wherein the first signal indicative of the motor back emf is generated based on variables of the set of state variables; and estimating a motor speed based on the variables of the set of state variables, wherein the second signal indicative of the motor back emf is generated based on the estimated motor speed.

In an embodiment, a non-transitory computer-readable medium's contents cause motor control circuitry to perform a method, the method comprising: monitoring motor drive signals provided to a motor; generating a first signal indicative of a motor back electromotive force (back emf) based on the monitoring; generating a second signal indicative of the motor back emf based on the monitoring; comparing the first signal indicative of the motor back emf to the second signal indicative of the motor back emf; and detecting a locked-rotor condition of the motor based on the comparing.

### BRIEF DESCRIPTION OF THE SEVERAL VIEWS OF THE DRAWINGS

FIG. 1 is a functional block diagram of an embodiment of a device or system having a motor and a motor controller according to an embodiment.

FIG. 2 is a conceptual diagram illustrating a back electromotive force (back emf) of a motor.

FIG. 3 is a functional block diagram of an embodiment of a device or system having a motor and a motor controller according to an embodiment.

FIG. 4 is a functional block diagram of an embodiment of a motor controller according to an embodiment.

FIG. 5 illustrates an embodiment of a method of detecting a locked motor rotor.

FIGS. 6A to 6D illustrate example signals in the context of a fan motor of an airconditioner in a normal operating condition.

FIGS. 7A to 7C illustrate example signals in the context of a fan motor of an airconditioner in a locked-rotor condition with a rotor locked for testing.

FIGS. 8A to 8E illustrate additional example signals in the context of a fan motor of an airconditioner in a locked-rotor condition with a rotor locked for testing.

### DETAILED DESCRIPTION

In the following description, certain details are set forth in order to provide a thorough understanding of various embodiments of devices, systems, methods and articles. However, one of skill in the art will understand that other embodiments may be practiced without these details. In other instances, well-known structures and methods associated with, for example, circuits, such as transistors, multipliers, adders, dividers, comparators, transistors, integrated circuits, logic gates, finite state machines, memories, interfaces, bus systems, etc., motors, such as rotors, coils, brushes, magnets, etc., have not been shown or described in detail in some figures to avoid unnecessarily obscuring descriptions of the embodiments.

Unless the context requires otherwise, throughout the specification and claims which follow, the word “comprise” and variations thereof, such as “comprising.” and “comprises.” are to be construed in an open, inclusive sense, that is, as “including, but not limited to.” Reference to “at least one of” shall be construed to mean either or both the disjunctive and the inclusive, unless the context indicates otherwise.

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure.

The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn are not necessarily intended to convey any information regarding the actual shape of particular elements, and have been selected solely for ease of recognition in the drawings.

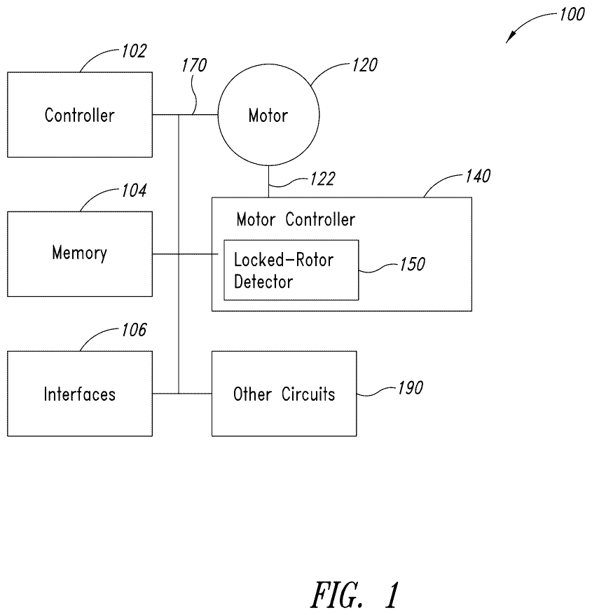

FIG. 1 is a functional block diagram of an embodiment of a device or system 100 of the type to which the embodiments which will be described may apply. The system 100 comprises a controller circuit 102, which may include one or more processing cores (not shown). The processing cores may comprise, for example, one or more processors, a state machine, a microprocessor, a programmable logic circuit, discrete circuitry, logic gates, registers, etc., and various combinations thereof. The controller may control overall operation of the system 100, execution of application programs (e.g., a wash cycle of a dishwasher) by the system 100, etc. The system 100 includes a memory 104, such as one or more volatile and/or non-volatile memories which may store, for example, all or part of instructions and data related to control of the system 100, applications and operations performed by the system 100, etc.

The system 100 also includes a motor 120 (e.g., a water pump motor of a dishwasher, a fan motor, etc.) and a motor controller circuit 140, which, in operation, generates one or more signals to control operation of the motor 120. The motor 120 may be, for example, a sensorless AC or DC PMSM motor, and the motor controller 140 may employ a flux oriented control sensorless control strategy to control operation of the motor 120.

In a locked-rotor condition, a motor may not start in response to a control signal, or an incorrect control signal may be applied based on an incorrect estimated speed when a real speed is zero. This can result in damage to the motor 120, to the motor controller 140, or to other components of the system 100. It is noted that a locked-rotor may oscillate in position in responds to control signals to drive the motor, rather than be locked in a stationary position.

As noted above, conventionally locked-rotor detection may be performed using a Hall sensor or other position sensor (e.g., an encoder, a resolver). Additional cabling, interfaces, power, space (e.g., inside the motor casing) and signaling, however, are required for the position sensors (thus, increasing the costs), and the position sensors may decrease the system reliability. Sensor-less motor control systems (e.g., sensor-less PMSM motor controllers), are known, and may use a state observer together with open or closed loop flux oriented control, or a combination of open and closed loop control. Such sensor-less motor controllers, however, may have difficulty accurately detecting a locked rotor (e.g., a water pump in a dishwasher system may developed a locked rotor when something blocks the water loop or in a heavy load condition).

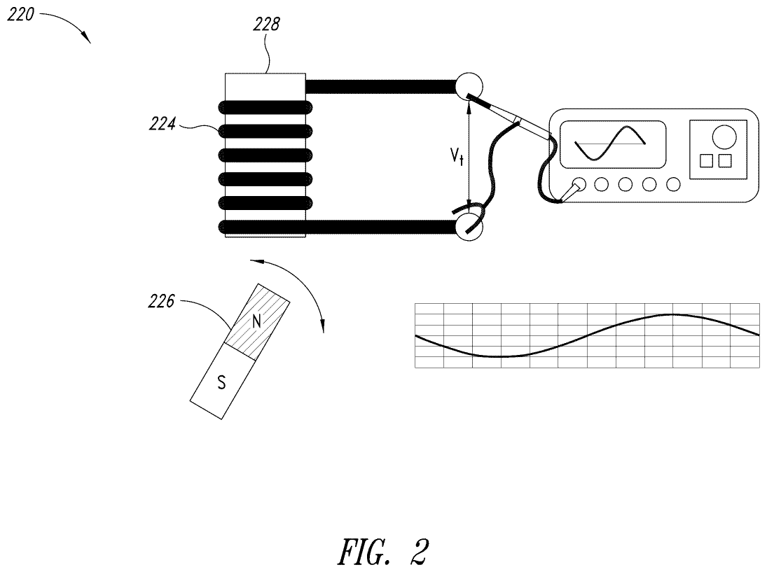

The inventors have realized that comparing two indications of a back EMF of a motor may be employed to improve the accuracy of detection of a locked-rotor condition. This may be particularly useful, for example, in systems having motors which do not include rotor position sensors, such as a sensor-less PMSM motor. As illustrated, the motor controller 140 includes locked-rotor detection circuitry 150, which, in operation, detects a locked-rotor condition on the motor based on two indications of the back EMF of the motor, for example, as discussed in more detail with reference to FIGS. 2-XX.

The system 100 may include one or more interfaces 106 (e.g., wireless communication interfaces, wired communication interfaces, user-control interfaces, etc.), one or more other circuits 190, which may include power supplies, actuators, sensors (e.g., accelerometers, pressure sensors, temperature sensors, etc), and a main bus system 170. The main bus system 170 may include one or more data, address, power and/or control buses coupled to the various components of the system 100. The system 100 also may include additional bus systems such as motor bus system 122, which communicatively couples the motor controller 140 to the motor 120.

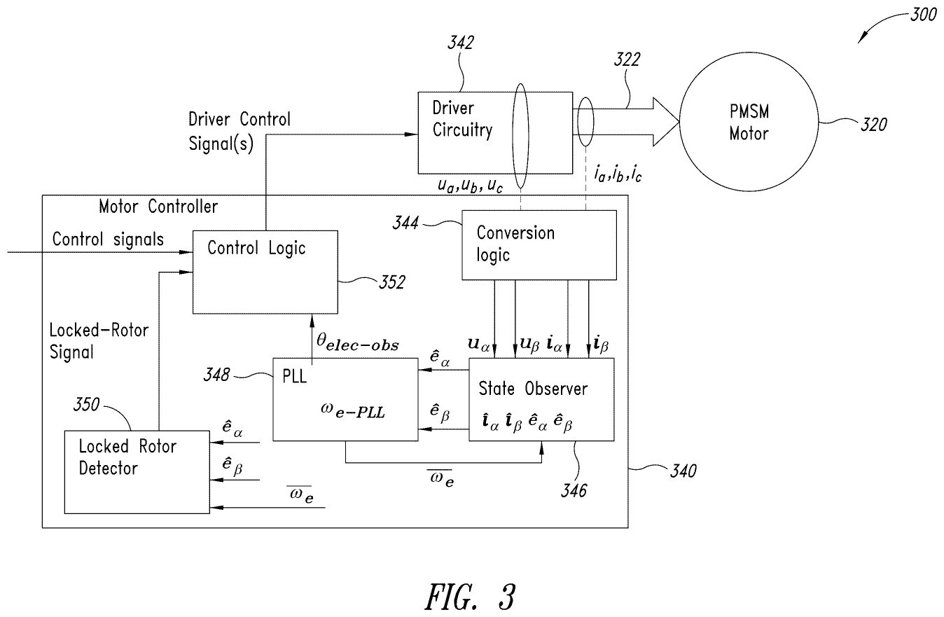

In some embodiments, the system 100 may include more components than illustrated, may include fewer components than illustrated, may split illustrated components into separate components, may combine illustrated components, etc., and various combinations thereof. For example, the motor controller 140 and the controller 102 may be combined in some embodiments. In some embodiments, driver circuitry may be coupled between the motor controller 140 and the motor 120 (see driver circuitry 342 of FIG. 3). In some embodiments, the locked-rotor detector 150 may be implemented using software executed by a processor (e.g., a processor of the controller 102, of the motor controller 140, etc.), by a state machine, etc.

FIG. 2 is a conceptual diagram illustrating the concept of a back EMF of a coil 224 of a motor 220 having a rotor 226. The coil 224 as illustrated has a core 228. The terminal voltage Vₜ of a motor coil may be measured and may serve as an indication of the back EMF of the coil. In the case of an AC PMSM, the terminal voltage VI may take the form of a sinusoid wave, as illustrated. In the case of a DC PMSM, the terminal voltage may have a trapezoidal wave shape. When the rotor (e.g., a magnet) is rotated, a magnetic field is generated in the coil 224 and in the core 228. The back EMF is proportional to the rotational speed of the rotor 226, and thus the terminal voltage VI is proportional to the rotational speed of the rotor 226.

FIG. 3 illustrates an embodiment of a system 300 having a motor 320, a motor controller 340, and motor driver circuitry 342, which may be employed, for example, in the embodiment of a system 100 of FIG. 1. The motor 320 as illustrated is a PMSM motor (e.g., an AC PMSM motor). The motor controller 340, in operation, senses currents and voltages associated with the driving circuitry (e.g., drive and reference voltages (uₐ, u_{b}, u_{c}) of the driver circuitry supplied to a three-phase AC PMSM motor; currents iₐ, i_{b} and i_{c} can be detected), and generates one or more driver control signals to control operation of the driver circuitry 342. The driver circuitry 342, in operation, generates, based on the driver control signals, drive signals on the motor bus 322 to drive the motor 320. The motor controller, as illustrated, includes conversion logic or circuitry 344, a state observer circuit 346, a phase-locked-loop (PLL) 348, a locked rotor detector or circuit 350 and control logic 352.

The conversion logic 344 converts the sensed currents and voltages to rotational representations, for example, using a transformation, such as a Clarke transformation, a Park transformation, inverse transformations, etc., and various combinations thereof. PI controllers may be employed in the conversion logic 334. The rotational representations, as illustrated u_{α}, u_{β}, i_{α}, i_{β}, are provided as input to the state observer circuit 346, which maintains state variables \hat{l}_{α}, \hat{l}_{β} (rotational current state variables), and ê_{α}, ê_{β} (rotational back emf state variables), based on the rotational representations and on an average rotational speed ω̅ₑ generated by the PLL 348. The PLL 348 generates a motor speed indicator ω_{e-PLL} based on the state variables ê_{α}, ê_{β}. Based on the generated motor speed indicator, ω_{e-PLL}, the PLL 348 generates a rotor angle signal θ_{elec-obs} provided to the control logic 352, and generates the average rotational speed ω̅ₑ provided as delayed feedback to the state observer circuit 346. The conversion logic 344, state observer circuit 346 and the PLL 348 may operate in a conventional manner.

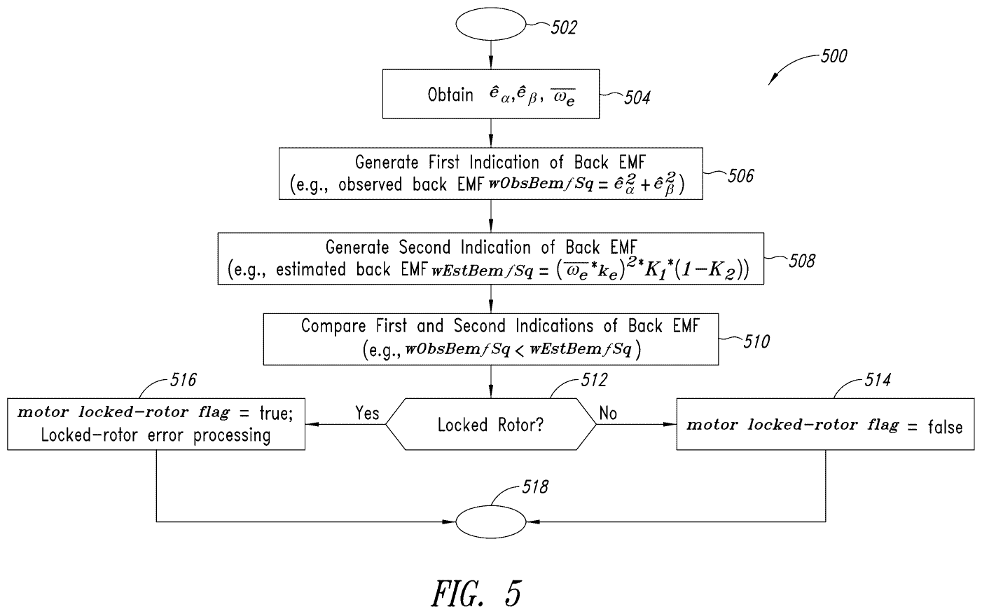

The locked rotor detector 350, in operation, generates a locked rotor signal based on the state variables ê_{α}, ê_{β} maintained by the state observer 346 and the average rotational speed ω̅ₑ generated by the PLL 348. As discussed in more detail with reference to FIG. 5, a first indication of a back emf is generated based on the state variables ê_{α}, ê_{β} maintained by the state observer 346 (an observed indication of the back emf), and a second indication of a back emf is generated based on the indication of the average rotational speed ω̅ₑ generated by the PLL 348 (an estimated indication of the back emf). The observed and the estimated indicators of the back emf are compared, and a locked-rotor signal is generated based on the comparison.

The control logic 352 generates one or more driver control signals based on the rotor angle signal θ_{elec-obs}, the locked rotor signal and any received control signals (e.g., such as start or stop signals, increase or decrease speed signals, from the controller 102 of FIG. 1, etc.). In response to receipt of a locked rotor signal, the control logic may initiate error processing to address the locked rotor condition, such as, for example, generating driver control signals to stop driving the motor, resetting the state observer and the PLL, generating an error signal (e.g., sending a signal to controller 102 of FIG. 1), etc., or various combinations thereof. In some embodiments, the control logic may respond to a locked-rotor detection by trying to restart the motor a threshold number of times, and generate an error signal (e.g., check water loop), if a locked-rotor error continues to be detected.

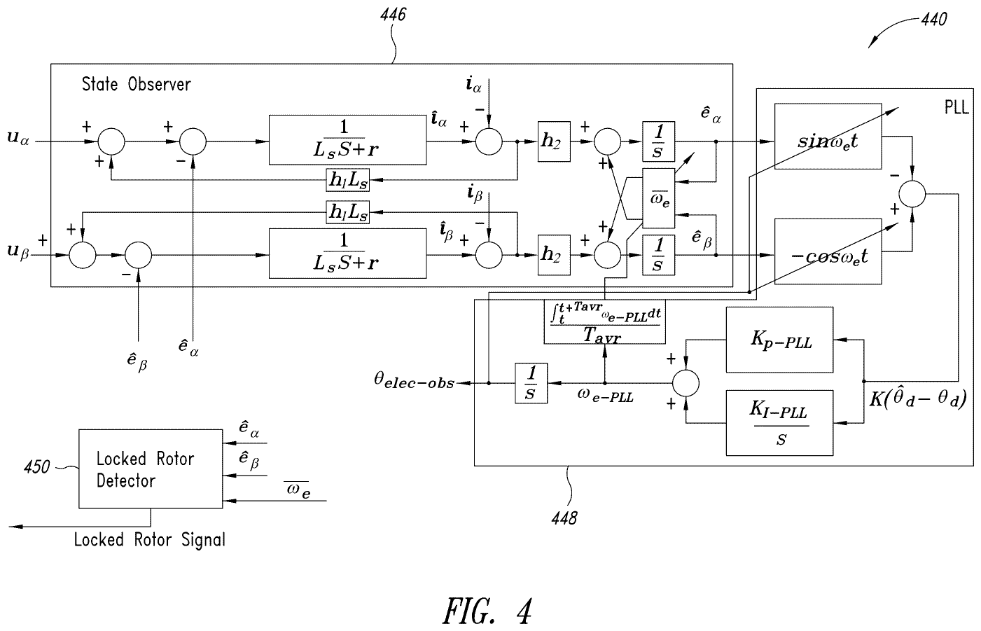

FIG. 4 is a partial functional block diagram of an embodiment of a motor controller 440, which shows in more detail an embodiment of a state observer 446 and an embodiment of a PLL 448, which respectively maintain the state variables ê_{α}, ê_{β} and generate the average rotational speed ω̅ₑ used by the locked rotor detector 450 to detect a locked rotor condition. The motor controller 440 may, for example, by employed in embodiments of the system 100 of FIG. 1 or in embodiments of the system 300 of FIG. 3. In FIG. 4,
\hat{l}_{α}, \hat{l}_{β}, ê_{α}, ê_{β} are the state variables of the state observer 446;
Lₛ is a motor induction parameter (see motor 320);
r is a motor resistance parameter (see motor 320);
k_{E} is a motor BackEMF constant (see motor 320);
h₁, h₂ are gain settings of the state observer 446;
ω_{e-PLL} is a motor speed determined by the PLL 448;
ω̅ₑ is average motor speed determined by the PLL 448;
Tₐᵥᵣ is a time lag used to calculate average de;
\hat{θ}_{d} is an estimated rotor angle;
θ_{d} is a real rotor angle;
θ_{elec-obs} is a rotor angle determined by the PLL and used by the control system (e.g., the control logic 352 of FIG. 3); and
K_{P-PLL}, K_{I-PLL} are gain settings of the PLL 448.

In some embodiments, a difference between the estimated rotor angle and the real motor angle (\hat{θ}_{d}-θ_{d}) may be determined using ê_{α}, ê_{β}.

Embodiments of the system 300 of FIG. 3 and of the motor controller 440 of FIG. 4 may include fewer components than illustrated, may include more components than illustrated, may split illustrated components into separate components, may combine illustrated components, etc., and various combinations thereof. For example, the state observer 346 of FIG. 3 may include the conversion logic 344, or the conversion logic 344 may be incorporated into the driver circuitry 342. In another example, in some embodiments the motor controllers 340, 440 may include a processor which, in operation, implements one or more of the conversion logic 344, state observer 346, PLL 348, locked rotor detector 350, and control logic 352, for example, by executing instructions stored in a memory, operating a state machine, etc., and various combinations thereof. In another example, the control logic 352 may include the locked rotor detector 350.

FIG. 5 illustrates an embodiment of a method 500 of detecting a locked rotor, which may be performed, for example, by system 100 of FIG. 1, the locked rotor detector 350 of the system 300 of FIG. 3, the locked rotor detector 450 of the motor controller 440 of FIG. 4, etc. The method 500 of FIG. 5 will be described for convenience with reference to FIGS. 3 and 4.

The method 500 starts at 502. The method 500 may be started, for example, as part of motor control routine executed by the motor controller 340, 440, etc. For example, the method 500 may run periodically or continuously during a motor control routine, or may be activated when an estimated or measured back emf is, for example, below a threshold value. The method 500 proceeds from 502 to 504.

At 504, the method 500 obtains values of variables employed to generate first and second indications of the back emf, for example, to generate an observed indication of a back EMF of a motor and to generate an estimated indication of a back emf of the motor. The first indication of the back emf may be based on the state variables ê_{α}, ê_{β} maintained by a state observer of the motor controller, such as the state observer 346 of the motor controller 340 of FIG. 3 or the state observer 446 of the motor controller 440 of FIG. 4. The second indication of the back emf may be based on the average rotational speed \hat{ω}ₑ generated by the PLL 348, 448. Thus, at 504, the method 500 may obtain values of the state variables ê_{α}, ê_{β}, and a value of the estimated average speed ω̅ₑ. The method 500 proceeds from 504 to 506.

At 506 the method 500 generates a first indication (e.g., a signal) of a back emf of a motor controlled by the motor controller. For example, as illustrated the first indication of the back emf may be an observed back emf signal wObsBemfsq generated based on the state variables ê_{α}, ê_{β}, for example, according to:

$$wObsBemfSq = {\hat{e}}_{α}^{2} + {\hat{e}}_{β}^{2} .$$

The method 500 proceeds from 506 to 508, where the method 500 generates a second indication (e.g., a signal) of a back emf of a motor controlled by the motor controller. For example, as illustrated the second indication of the back emf may be an estimated back emf signal wEstBemfsq generated based on the estimated average speed ω̅ₑ, for example, according to:

$$wEstBemfSq = {( \overline{{ω}_{e}} * {k}_{E} )}^{2} * {K}_{1} * ( 1 - {K}_{2} ) ,$$

where k_{E} is a motor BackEMF constant, and K₁ and K₂ are gain values selected to apply a desired scaling for wEstBemfsq for comparing. The method 500 proceeds from 508 to 510.

At 510, the method 500 compares the first and second indications of a back emf. For example, the method 500 may determine whether the first indication of the back emf is smaller than the second indication of the back emf. As illustrated, the comparing comprises determining whether wObsBemfSq<wEstBemfSq. In some embodiments, filtering may be applied to the first, to the second, or to both indications of a back emf prior to the comparing. For example, a low pass filter may be applied to the observed indication of the back emf used in the comparison. The method 500 proceeds from 510 to 512.

At 512, the method 500 determines whether a locked rotor condition exists. For example, when the comparison indicates the first indication of the back emf is less than the second indication of the back emf, the method may determine at 512 that a locked rotor condition is indicated. Some embodiments may consider other information is deciding whether a locked-rotor condition exists, such as whether the comparison indicates the first indication of the back emf is less than the second indication of the back emf for a threshold period of time.

When it is not determined at 512 that a locked-rotor condition exists, the method 500 proceeds from 512 to 514, where a locked rotor flag is set to false. The method 500 proceeds from 514 to 518. When it is determined at 512 that a locked-rotor condition exists, the method 500 proceeds from 512 to 516, where a locked rotor flag is set to true and locked-rotor error processing may be initiated (e.g., generating control signals to stop the motor, generating an error signal, generating signals to free the locked rotor, etc., or combinations thereof). The method 500 proceeds from 516 to 518, where the method 500 may terminate, may perform other processes, etc.

Embodiments of methods of detecting a locked rotor condition may contain additional acts not shown in FIG. 5, may not contain all of the acts shown in FIG. 5, may perform acts shown in FIG. 5 in various orders, and may be modified in various respects. For example, the method 500 may perform acts 506 and 508 in parallel or in another order, may combine acts 510 and 512, etc.

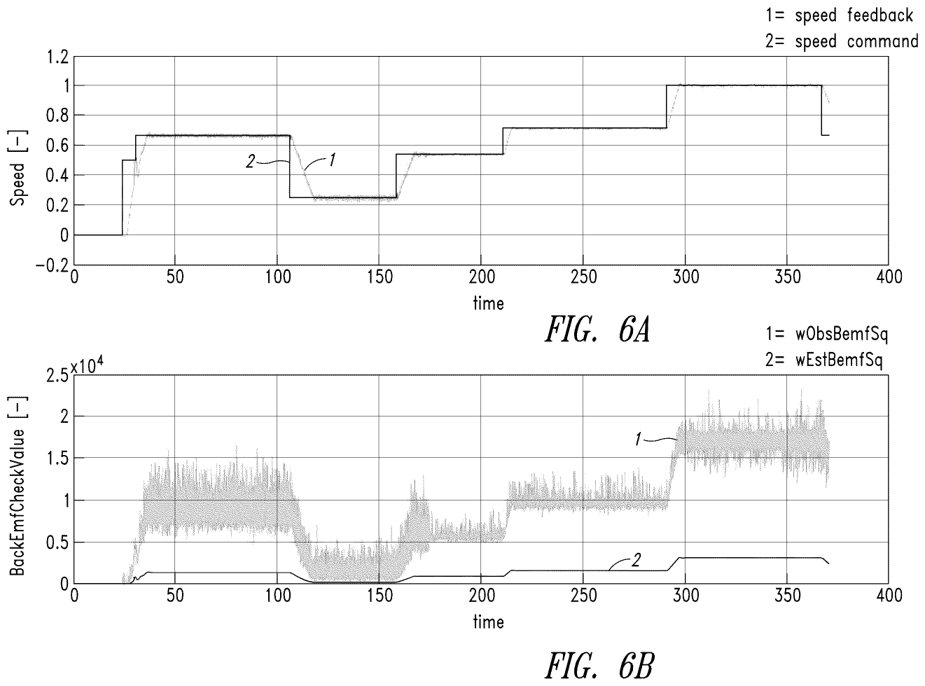

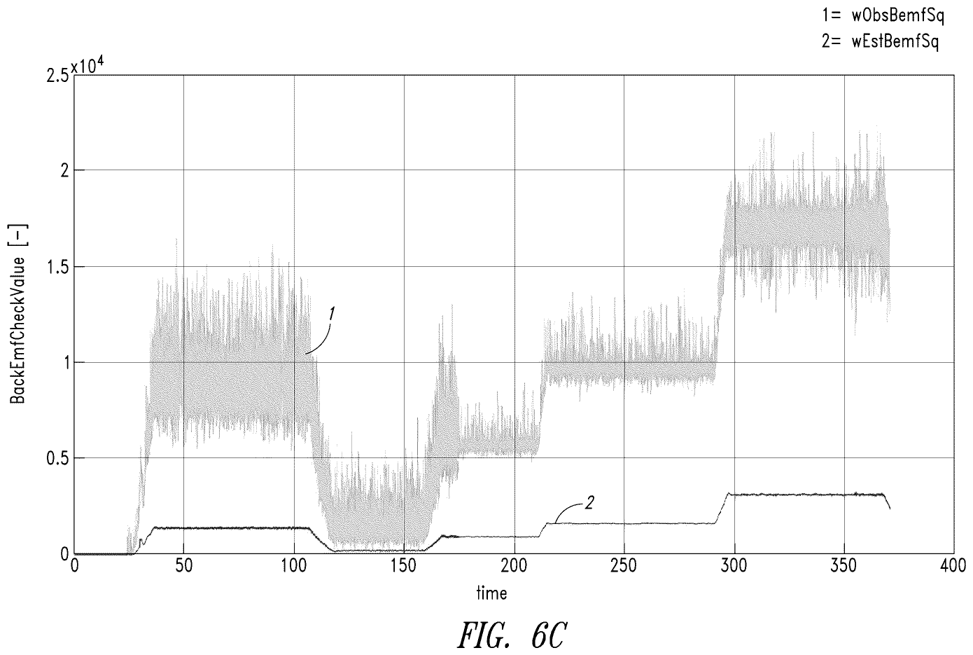

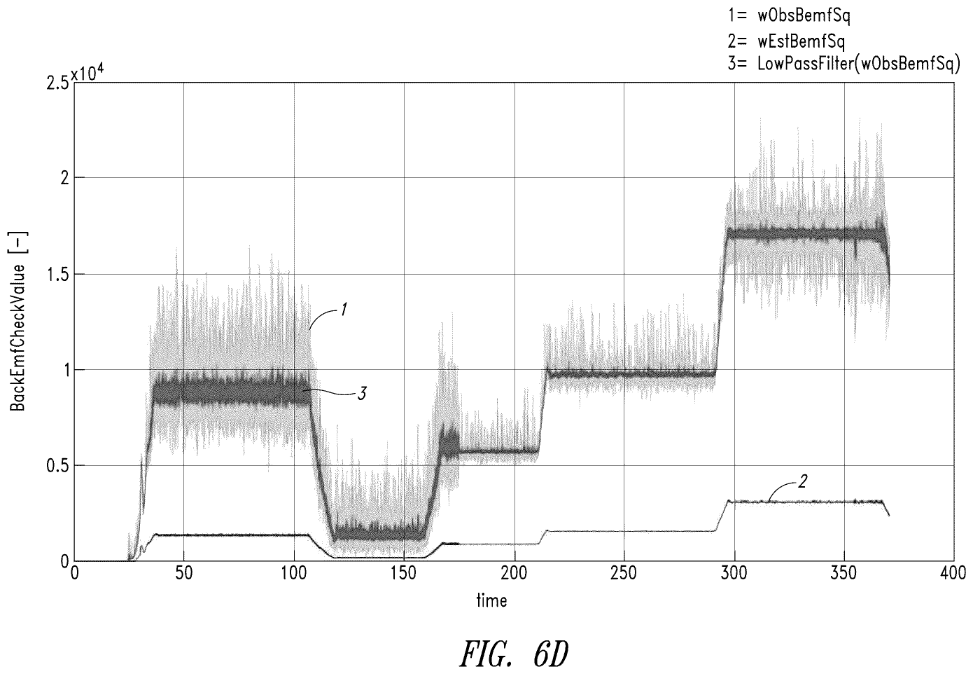

FIGS. 6A to 6D illustrate example signals in the context of a fan motor of an airconditioner in a normal operating condition. FIG. 6A illustrates a comparison of an example speed command signal to an example speed feedback signal. As illustrated, the speed command controls the fan motor of the air conditioner. The speed command is set to several common speed values. The comparison indicates that the motor speed generally responds to the speed command in an expected manner with a ramp up or down to the commanded speed. FIG. 6B to 6D illustrate example observed back emf signals and example estimated back emf signals. As shown in FIGS. 6B and 6C, the observed indication of the back emf is always larger than the estimated indication of the back emf. As can be seen in FIG. 6C, the observed indication of the back emf may be a noisy signal. FIG. 6D illustrates the applying of an optional low-pass filtering to the observed back emf signal.

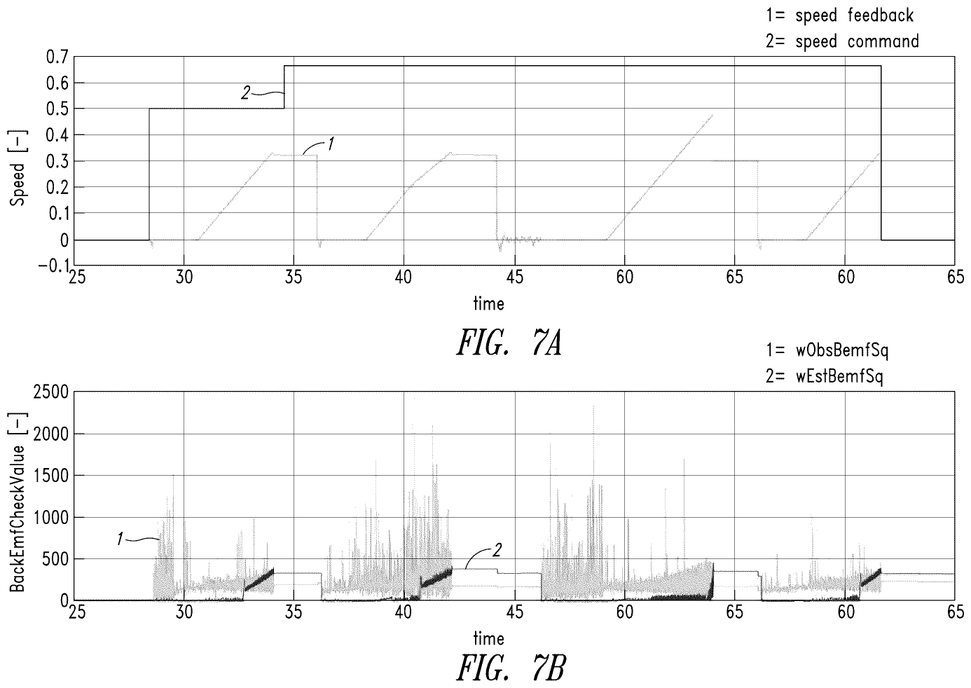

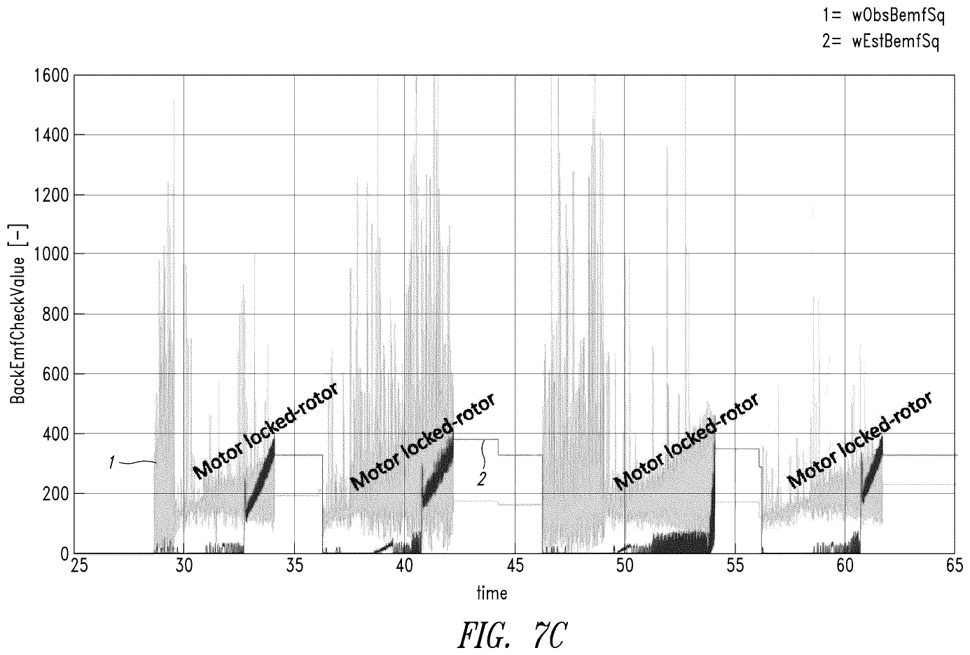

FIGS. 7A to 7C illustrate example signals in the context of a fan motor of an airconditioner in a locked-rotor condition with a rotor locked for testing. FIG. 7A illustrates a comparison of an example speed command signal to an example speed feedback signal. The comparison indicates that the motor repeatedly attempts, unsuccessfully, to respond to the speed command. FIGS. 7B and 7C illustrate example observed back emf signals and example estimated back emf signals in the locked-rotor condition. As shown in FIGS. 7B and 7C, the observed indication of the back emf is initially larger than the estimated indication of the back emf, but within a short period of time the estimated indication of the back emf becomes larger than the observed indication of the back emf, which serves as an indication of a locked rotor. Four detections of the locked-rotor condition are illustrated in FIGS. 7B and 7C.

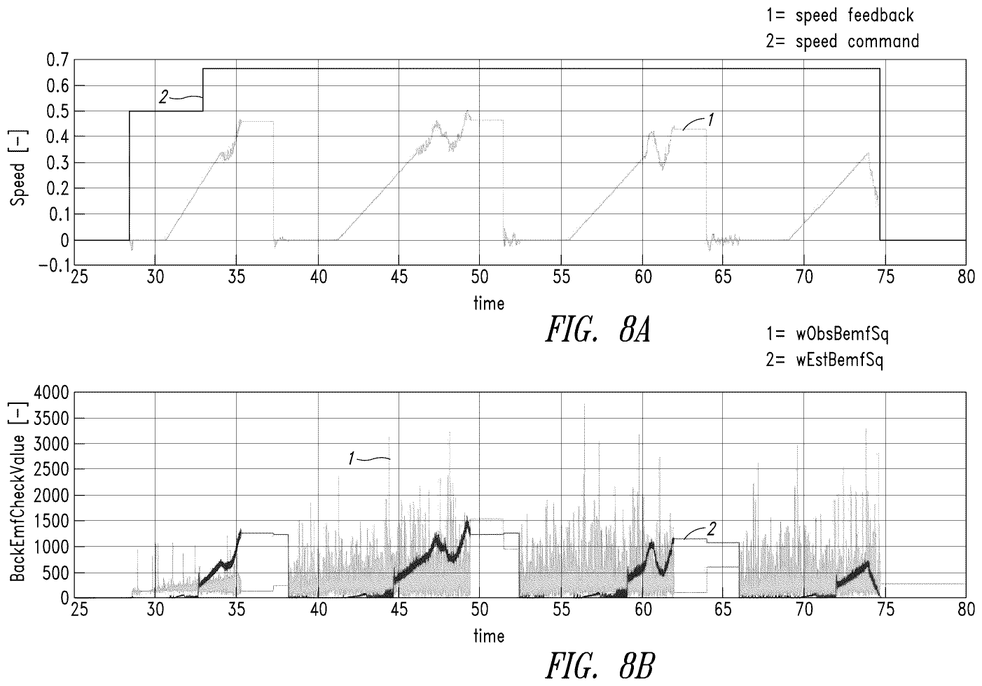

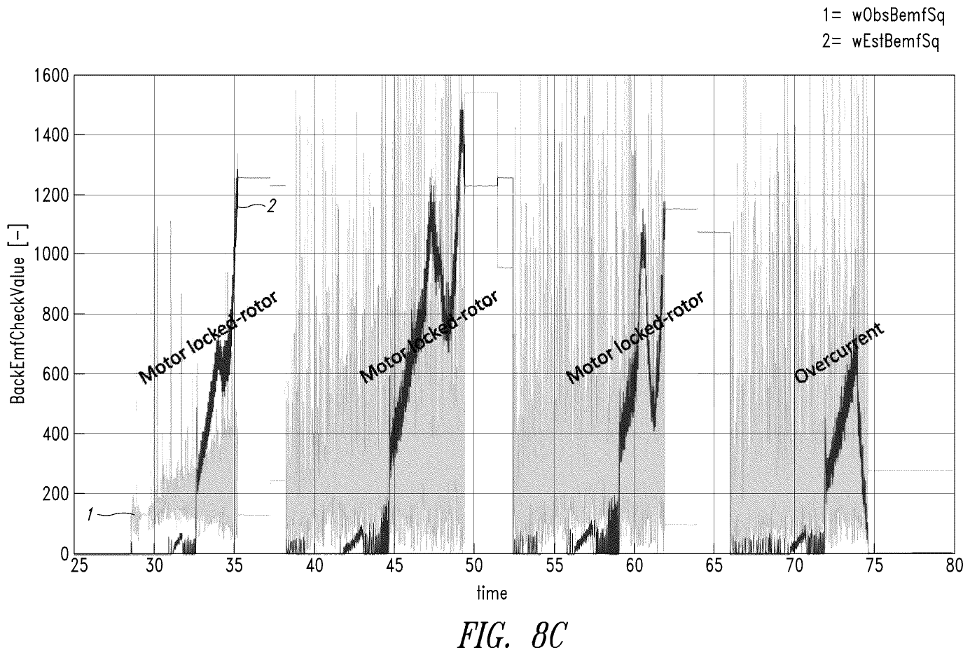

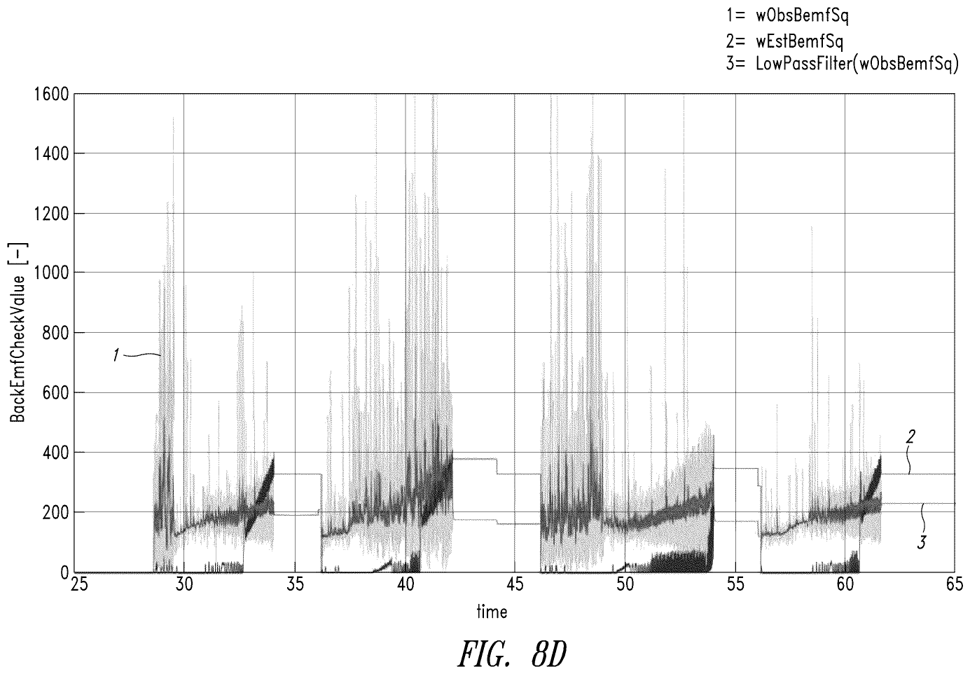

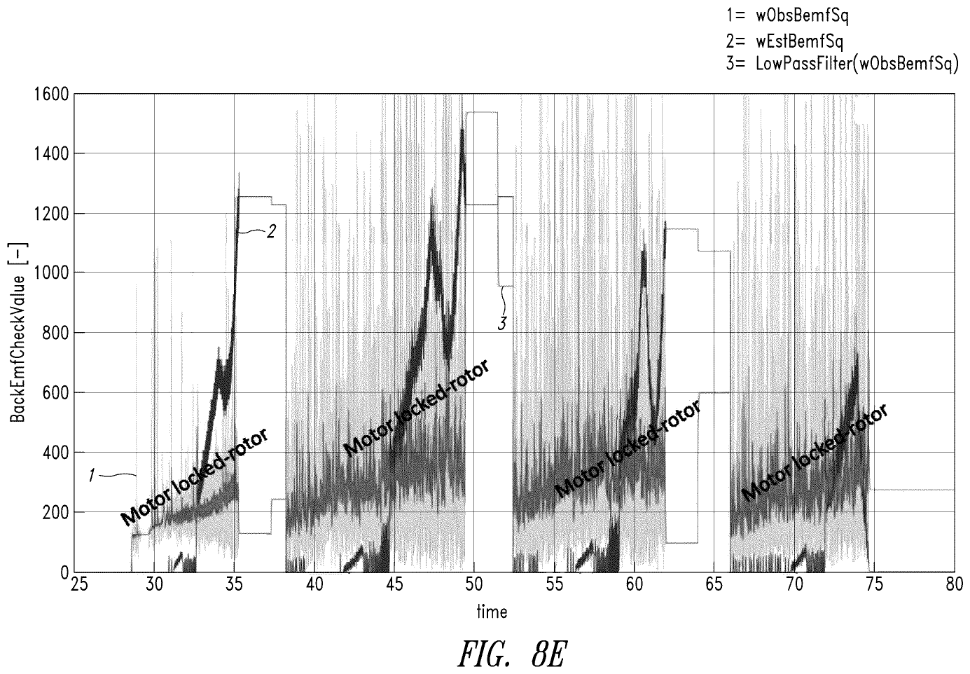

FIGS. 8A to 8E illustrate additional example signals in the context of a fan motor of an airconditioner in a locked-rotor condition with a rotor locked for testing. As compared to FIGS. 7A to 7C, other operational parameters of the system have been adjusted. FIG. 8A illustrates a comparison of an example speed command signal to an example speed feedback signal. The comparison indicates that the motor repeatedly attempts, unsuccessfully, to respond to the speed command. FIGS. 8B to 8E illustrate example observed back emf signals and example estimated back emf signals in the locked-rotor condition. As shown in FIGS. 8B and 8C, the observed indication of the back emf is initially larger than the estimated indication of the back emf, but within a short period of time the estimated indication of the back emf becomes larger than the observed indication of the back emf, which serves as an indication of a locked rotor. Three successful detections of a locked rotor condition are shown in FIGS. 8B and 8C. The three detections of the locked rotor condition are followed by an indication of an overcurrent error, which should instead be an indication of a locked rotor (although both conditions may exist).

FIGS. 8D and 8E illustrate the application of a low-pass filter to the observed indication of the back emf. As compared to FIGS. 8B and 8C, the time to detection of the locked-rotor condition is reduced, and the reliability is improved as the comparison of the filtered observed indication to the estimated indication of the back emf correctly detects the locked rotor condition, instead of detecting an overcurrent condition in the fourth test period.

In an embodiment, a device comprises an input, which, in operation, receives signals indicative of currents and voltages of a motor drive signal, and control circuitry coupled to the input. The control circuitry, in operation: generates a first signal indicative of a motor back electromotive force (back emf) based on the received signals; generates a second signal indicative of the motor back emf based on the received signals; compares the first signal indicative of the motor back emf to the second signal indicative of the motor back emf; and detects a motor locked-rotor condition based on the comparison. In an embodiment, the control circuitry comprises: a state observer, which, in operation, maintains a set of state variables based on the received signals, wherein the first signal indicative of the motor back emf is generated based on variables of the set of state variables; and a phase-locked-loop coupled to the state observer, wherein the phase-locked-loop, in operation, estimates a motor speed based on the variables of the set of state variables, wherein the second signal indicative of the motor back emf is generated based on the estimated motor speed. In an embodiment, the set of state variables comprises rotational current state variables and rotational back emf state variables, the first signal indicative of the motor back emf is based on the rotational back emf state variables of the set of state variables, and the second signal indicative of the motor back emf is based on an average of the motor speed estimated by the phase-locked-loop. In an embodiment, the generating the first signal indicative of the motor back emf comprises: squaring a value of a first rotational back emf state variable of the set of state variables; squaring a value of a second rotational back emf state variable of the set of state variables; and adding the squared value of the first rotational back emf state variable and the squared value of the second rotational back emf state variable, generating an observed signal indicative of the motor back emf. In an embodiment, the generating the first signal indicative of the motor back emf comprises applying a low pass filter to the observed signal indicative of the motor back emf. In an embodiment, the second signal indicative of the motor back emf is an estimated motor back emf generated according to:

$$wEstBemfSq = {( \overline{{ω}_{e}} * {k}_{E} )}^{2} * {K}_{1} * ( 1 - {K}_{2} ) ,$$

where wEstBemfSq represents the second signal indicative of the motor back emf, ω̅ₑ represents an average estimated speed generated by the phase-locked loop, K_{E} represents a motor back emf constant, and K₁ and K₂ are gain values. In an embodiment, the control circuitry, in operation, in response to the comparing indicating the first signal indicative of the motor back emf is less than second signal indicative of the motor back emf, detects a motor locked-rotor condition.

In an embodiment, a system, comprising a motor, which, in operation, receives motor drive signals; and control circuitry coupled to the motor. The control circuitry, in operation: monitors the motor drive signals; generates a first signal indicative of a motor back electromotive force (back emf) based on the monitoring; generates a second signal indicative of the motor back emf based on the monitoring; compares the first signal indicative of the motor back emf to the second signal indicative of the motor back emf; and detects a motor locked-rotor condition based on the comparing. In an embodiment, the control circuitry comprises: state observer circuitry, which, in operation, maintains a set of state variables based on the monitoring, wherein the first signal indicative of the motor back emf is generated based on variables of the set of state variables; and a phase-locked-loop coupled to the state observer circuitry, wherein the phase-locked-loop, in operation, estimates a motor speed based on the variables of the set of state variables, wherein the second signal indicative of the motor back emf is generated based on the estimated motor speed. In an embodiment, the set of state variables comprises rotational current state variables and rotational back emf state variables, the first signal indicative of the motor back emf is based on the rotational back emf state variables of the set of state variables, and the second signal indicative of the motor back emf is based on an average of the motor speed estimated by the phase-locked-loop. In an embodiment, the generating the first signal indicative of the motor back emf comprises: squaring a value of a first rotational back emf state variable of the set of state variables; squaring a value of a second rotational back emf state variable of the set of state variables; and adding the squared value of the first rotational back emf state variable and the squared value of the second rotational back emf state variable, generating an observed signal indicative of the motor back emf. In an embodiment, the generating the first signal indicative of the motor back emf comprises applying a low pass filter to the observed signal indicative of the motor back emf. In an embodiment, the second signal indicative of the motor back emf is an estimated motor back emf generated according to:

$$wEstBemfSq = {( \overline{{ω}_{e}} * {k}_{E} )}^{2} * {K}_{1} * ( 1 - {K}_{2} ) ,$$

where wEstBemfSq represents the second signal indicative of the motor back emf, ω̅ₑ represents an average estimated speed generated by the phase-locked loop, k_{E} represents a motor back emf constant, and K₁ and K₂ are gain values. In an embodiment, the control circuitry, in operation, in response to the comparing indicating the first signal indicative of the motor back emf is less than second signal indicative of the motor back emf, detects a motor locked-rotor condition. In an embodiment, the motor is a permanent magnet synchronous motor (PMSM). In an embodiment, the motor is an alternating current (AC) PMSM.

In an embodiment, a method of controlling a permanent magnet synchronous motor (PMSM) comprises: monitoring motor drive signals provided to the motor; generating a first signal indicative of a motor back electromotive force (back emf) based on the monitoring; generating a second signal indicative of the motor back emf based on the monitoring; comparing the first signal indicative of the motor back emf to the second signal indicative of the motor back emf; and detecting a locked-rotor condition of the motor based on the comparing. In an embodiment, the method comprises: maintaining a set of state variables based on the monitoring, wherein the first signal indicative of the motor back emf is generated based on variables of the set of state variables; and estimating a motor speed based on the variables of the set of state variables, wherein the second signal indicative of the motor back emf is generated based on the estimated motor speed. In an embodiment, the set of state variables comprises rotational current state variables and rotational back emf state variables, the first signal indicative of the motor back emf is generated based on the rotational back emf state variables of the set of state variables, and the second signal indicative of the motor back emf is generated based on an average of the estimated motor speed. In an embodiment, the second signal indicative of the motor back emf is an estimated motor back emf generated according to:

$$wEstBemfSq = {( \overline{{ω}_{e}} * {k}_{E} )}^{2} * {K}_{1} * ( 1 - {K}_{2} ) ,$$

where wEstBemfSq represents the second signal indicative of the motor back emf, ω̅ₑ represents an average estimated speed generated by the phase-locked loop, k_{E} represents a back emf constant of the motor, and K₁ and K₂ are gain values. In an embodiment, the generating the first signal indicative of the motor back emf comprises: squaring a value of a first rotational back emf state variable of the set of state variables; squaring a value of a second rotational back emf state variable of the set of state variables; and adding the squared value of the first rotational back emf state variable and the squared value of the second rotational back emf state variable, generating an observed signal indicative of the motor back emf. In an embodiment, the generating the first signal indicative of the motor back emf comprises applying a low pass filter to the observed signal indicative of the motor back emf. In an embodiment, the method comprises: in response to the comparing indicating the first signal indicative of the motor back emf is less than second signal indicative of the motor back emf, detecting a motor locked-rotor condition. In an embodiment, the method comprises: in response to detecting a motor locked rotor condition, modifying the motor drive signals.

In an embodiment, a non-transitory computer-readable medium's contents cause motor control circuitry to perform a method, the method comprising: monitoring motor drive signals provided to a motor; generating a first signal indicative of a motor back electromotive force (back emf) based on the monitoring: generating a second signal indicative of the motor back emf based on the monitoring; comparing the first signal indicative of the motor back emf to the second signal indicative of the motor back emf; and detecting a locked-rotor condition of the motor based on the comparing. In an embodiment, the contents comprising instructions executed by the motor control circuitry. In an embodiment, the method comprises: in response to the comparing indicating the first signal indicative of the motor back emf is less than second signal indicative of the motor back emf, detecting a motor locked-rotor condition.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various embodiments and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The invention claimed is:

1. A device, comprising:
an input, which, in operation, receives signals indicative of currents and voltages of a motor drive signal; and
control circuitry coupled to the input, wherein the control circuitry, in operation:
generates a first signal indicative of a motor back electromotive force (back emf) based on the received signals;
generates a second signal indicative of the motor back emf based on the received signals;
compares the first signal indicative of the motor back emf to the second signal indicative of the motor back emf; and
detects a motor locked-rotor condition based on the comparison.

2. The device of claim 1, wherein the control circuitry comprises:
a state observer, which, in operation, maintains a set of state variables based on the received signals, wherein the first signal indicative of the motor back emf is generated based on variables of the set of state variables; and
a phase-locked-loop coupled to the state observer, wherein the phase-locked-loop, in operation, estimates a motor speed based on the variables of the set of state variables, wherein the second signal indicative of the motor back emf is generated based on the estimated motor speed.

3. The device of claim 2, wherein,
the set of state variables comprises rotational current state variables and rotational back emf state variables,
the first signal indicative of the motor back emf is based on the rotational back emf state variables of the set of state variables, and
the second signal indicative of the motor back emf is based on an average of the motor speed estimated by the phase-locked-loop.

4. The device of claim 3, wherein the generating the first signal indicative of the motor back emf comprises:
squaring a value of a first rotational back emf state variable of the set of state variables;
squaring a value of a second rotational back emf state variable of the set of state variables; and
adding the squared value of the first rotational back emf state variable and the squared value of the second rotational back emf state variable, generating an observed signal indicative of the motor back emf.

5. The device of claim 4, wherein the generating the first signal indicative of the motor back emf comprises applying a low pass filter to the observed signal indicative of the motor back emf.

6. The device of claim 5, wherein the second signal indicative of the motor back emf is an estimated motor back emf generated according to:
$$wEstBemfSq = {( \overline{{ω}_{e}} * {k}_{E} )}^{2} * {K}_{1} * ( 1 - {K}_{2} ) ,$$
where wEstBemfSq represents the second signal indicative of the motor back emf, ω̅ₑ represents an average estimated speed generated by the phase-locked loop, k_{E} represents a motor back emf constant, and K₁ and K₂ are gain values.

7. The device of claim 6, wherein the control circuitry, in operation,
in response to the comparing indicating the first signal indicative of the motor back emf is less than second signal indicative of the motor back emf, detects a motor locked-rotor condition.

8. The device of claim 1, wherein the control circuitry, in operation,
in response to the comparing indicating the first signal indicative of the motor back emf is less than second signal indicative of the motor back emf, detects a motor locked-rotor condition.

9. The device of claim 1, wherein the second signal indicative of the motor back emf is an estimated motor back emf generated according to:
$$wEstBemfSq = {( \overline{{ω}_{e}} * {k}_{E} )}^{2} * {K}_{1} * ( 1 - {K}_{2} ) ,$$
where wEstBemfSq represents the second signal indicative of the motor back emf, ω̅ₑ represents an average estimated speed generated by the phase-locked loop, k_{E} represents a motor back emf constant, and K₁ and K₂ are gain values.

10. A system, comprising:
a motor, which, in operation, receives motor drive signals; and
control circuitry coupled to the motor, wherein the control circuitry, in operation:
monitors the motor drive signals;
generates a first signal indicative of a motor back electromotive force (back emf) based on the monitoring;
generates a second signal indicative of the motor back emf based on the monitoring;
compares the first signal indicative of the motor back emf to the second signal indicative of the motor back emf; and
detects a motor locked-rotor condition based on the comparing.

11. The system of claim 10, wherein the control circuitry comprises:
state observer circuitry, which, in operation, maintains a set of state variables based on the monitoring, wherein the first signal indicative of the motor back emf is generated based on variables of the set of state variables; and
a phase-locked-loop coupled to the state observer circuitry, wherein the phase-locked-loop, in operation, estimates a motor speed based on the variables of the set of state variables, wherein the second signal indicative of the motor back emf is generated based on the estimated motor speed.

12. The system of claim 11, wherein,
the set of state variables comprises rotational current state variables and rotational back emf state variables,
the first signal indicative of the motor back emf is based on the rotational back emf state variables of the set of state variables, and
the second signal indicative of the motor back emf is based on an average of the motor speed estimated by the phase-locked-loop.

13. The system of claim 12, wherein the generating the first signal indicative of the motor back emf comprises:
squaring a value of a first rotational back emf state variable of the set of state variables;
squaring a value of a second rotational back emf state variable of the set of state variables; and
adding the squared value of the first rotational back emf state variable and the squared value of the second rotational back emf state variable, generating an observed signal indicative of the motor back emf.

14. The system of claim 13, wherein the generating the first signal indicative of the motor back emf comprises applying a low pass filter to the observed signal indicative of the motor back emf.

15. The system of claim 14, wherein the second signal indicative of the motor back emf is an estimated motor back emf generated according to:
$$wEstBemfSq = {( \overline{{ω}_{e}} * {k}_{E} )}^{2} * {K}_{1} * ( 1 - {K}_{2} ) ,$$
where wEstBemfSq represents the second signal indicative of the motor back emf, ω̅ₑ represents an average estimated speed generated by the phase-locked loop, k_{E} represents a motor back emf constant, and K₁ and K₂ are gain values.

16. The system of claim 15, wherein the control circuitry, in operation,
in response to the comparing indicating the first signal indicative of the motor back emf is less than second signal indicative of the motor back emf, detects a motor locked-rotor condition.

17. The system of claim 10, wherein the motor is a permanent magnet synchronous motor (PMSM).

18. The system of claim 17, wherein the motor is an alternating current (AC) PMSM.

19. A method of controlling a permanent magnet synchronous motor (PMSM), the method comprising:
monitoring motor drive signals provided to the motor;
generating a first signal indicative of a motor back electromotive force (back emf) based on the monitoring;
generating a second signal indicative of the motor back emf based on the monitoring;
comparing the first signal indicative of the motor back emf to the second signal indicative of the motor back emf; and
detecting a locked-rotor condition of the motor based on the comparing.

20. The method of claim 19, comprising:
maintaining a set of state variables based on the monitoring, wherein the first signal indicative of the motor back emf is generated based on variables of the set of state variables; and
estimating a motor speed based on the variables of the set of state variables, wherein the second signal indicative of the motor back emf is generated based on the estimated motor speed.

21. The method of claim 20, wherein,
the set of state variables comprises rotational current state variables and rotational back emf state variables,
the first signal indicative of the motor back emf is generated based on the rotational back emf state variables of the set of state variables, and
the second signal indicative of the motor back emf is generated based on an average of the estimated motor speed.

22. The method of claim 21, wherein the second signal indicative of the motor back emf is an estimated motor back emf generated according to:
$$wEstBemfSq = {( \overline{{ω}_{e}} * {k}_{E} )}^{2} * {K}_{1} * ( 1 - {K}_{2} ) ,$$
where wEstBemfSq represents the second signal indicative of the motor back emf, ω̅ₑ represents an average estimated speed generated by the phase-locked loop, k_{E} represents a back emf constant of the motor, and K₁ and K₂ are gain values.

23. The method of claim 22, wherein the generating the first signal indicative of the motor back emf comprises:
squaring a value of a first rotational back emf state variable of the set of state variables;
squaring a value of a second rotational back emf state variable of the set of state variables; and
adding the squared value of the first rotational back emf state variable and the squared value of the second rotational back emf state variable, generating an observed signal indicative of the motor back emf.

24. The method of claim 23, wherein the generating the first signal indicative of the motor back emf comprises applying a low pass filter to the observed signal indicative of the motor back emf.

25. The method of claim 19, comprising:
in response to the comparing indicating the first signal indicative of the motor back emf is less than second signal indicative of the motor back emf, detecting a motor locked-rotor condition.

26. The method of claim 25, comprising:
in response to detecting a motor locked rotor condition, modifying the motor drive signals.

27. A non-transitory computer-readable medium having contents which cause motor control circuitry to perform a method, the method comprising:
monitoring motor drive signals provided to a motor;
generating a first signal indicative of a motor back electromotive force (back emf) based on the monitoring;
generating a second signal indicative of the motor back emf based on the monitoring;
comparing the first signal indicative of the motor back emf to the second signal indicative of the motor back emf; and
detecting a locked-rotor condition of the motor based on the comparing.

28. The non-transitory computer-readable medium of claim 27, wherein the contents comprising instructions executed by the motor control circuitry.

29. The non-transitory computer-readable medium of claim 27, wherein the method comprises:
in response to the comparing indicating the first signal indicative of the motor back emf is less than second signal indicative of the motor back emf, detecting a motor locked-rotor condition.
